(19) United States
(12) Patent Application Publication
(10) Pub. No.: US 2005/0190565 A1
(43) Pub. Date: Sep. 1, 2005

(54) Structure of lampshade

(76) Inventor: Mei-Ju Juang, ShuLin City (TW)

Correspondence Address: BACON & THOMAS, PLLC, 625 SLATERS LANE, FOURTH FLOOR, ALEXANDRIA, VA, 22314, US

(21) Appl. No.: 10/785,987

(22) Filed: Feb. 26, 2004

(51) Int. Cl. F21V 11/00

(52) U.S. Cl. 362/351

(57) ABSTRACT

This invention relates to a structure of the lampshade, mainly comprising an upper ring, a lower ring, a shade, two retaining rings and a support sheet. It is so designed that the L shape retaining rings will be stuck the upper ring and lower ring respectively to form an adequate gap for receiving the support sheet. The support sheet will be inserted into the said gap become a cylindrical hollow and adhered together at the both ends by a piece of two sides adhesive tape so as to constitute a complete lampshade. This improved structure renders easy and quick assembly and disassembly, saving in production cost and time.

### FIELD OF THE INVENTION

This invention concerns a structure of the lampshade in which a piece of hard support sheet is wound together to form a cylindrical hollow in the place of welding work to weld the upper and lower rings together. It is easy and quick in assembly and disassembly and resulted much in time and cost saving.

### DESCRIPTION OF THE RELATED ART

Most prior art of the lampshades are made of a frame on which a shade is covered to prevent the light being dispersed. In considering the strength and safety, the frame is made from the metal rod material and welded together and finally wrapped the out perimeter with cloth shade to form a complete lampshade.

This metal frame ensures solidity, stability and strength, however, welding the frame to the upper and lower ring is time consuming and costly, it is not an economical practice.

View these shortcomings, the inventor, with his profession and long experience has dedicated great efforts for years to the improvement and finally come up a novel designed of improved lampshade for the benefit of the public. The main difference lies in that the metal frame of the lampshade is hereby replaced by a piece of hard support sheet in cylindrical hollow which is assembled between the upper ring and the lower ring. This practice eliminates the complexity of assembly and saves tremendous production cost.

### SUMMARY OF THE INVENTION

The main object of this invention is to provide an improvement differing from the traditional lampshade to achieve great saving in simple assembly and disassembly and much in production cost.

To achieve the above set object, the technological design covers an upper ring, a lower ring, a shade, two retaining rings and a piece of support sheet, in particular, these two L shaped retaining rings are stuck to the upper ring and lower ring respectively to form an adequate gap for receiving the support sheet. The support sheet will be inserted into the gap to become a cylindrical hollow and both ends of the support sheet is adhered together by a section of two side adhesive tape so to constitute a complete lampshade.

The novel lampshade provided in this invention requires no welding of the metal frame to the upper and lower rings. It is an easy, time and money saving practice. The upper ring, lower ring, and the retaining rings are easy to disassemble, store and handling, great saving in the consequent operations.

Other objects, features and advantages of the lampshade of this invention will be explained in great detail with the aid of embodiments as illustrated in the drawing attached.

### BRIEF DESCRIPTION OF DRAWINGS

FIG. 1 shows the disassembly of the lampshade of this invention.

FIG. 2 shows the assembly of the lampshade of this invention.

FIG. 3 shows the practical structure of the lampshade of this invention.

FIG. 3a shows the enlarged upper part of the shade of the lampshade of this invention.

FIG. 3b shows the enlarged lower part of the shade of the lampshade of this invention.

FIG. 4 shows individual components of the lampshade of this invention.

### DETAILED DESCRIPTION OF THE INVENTION

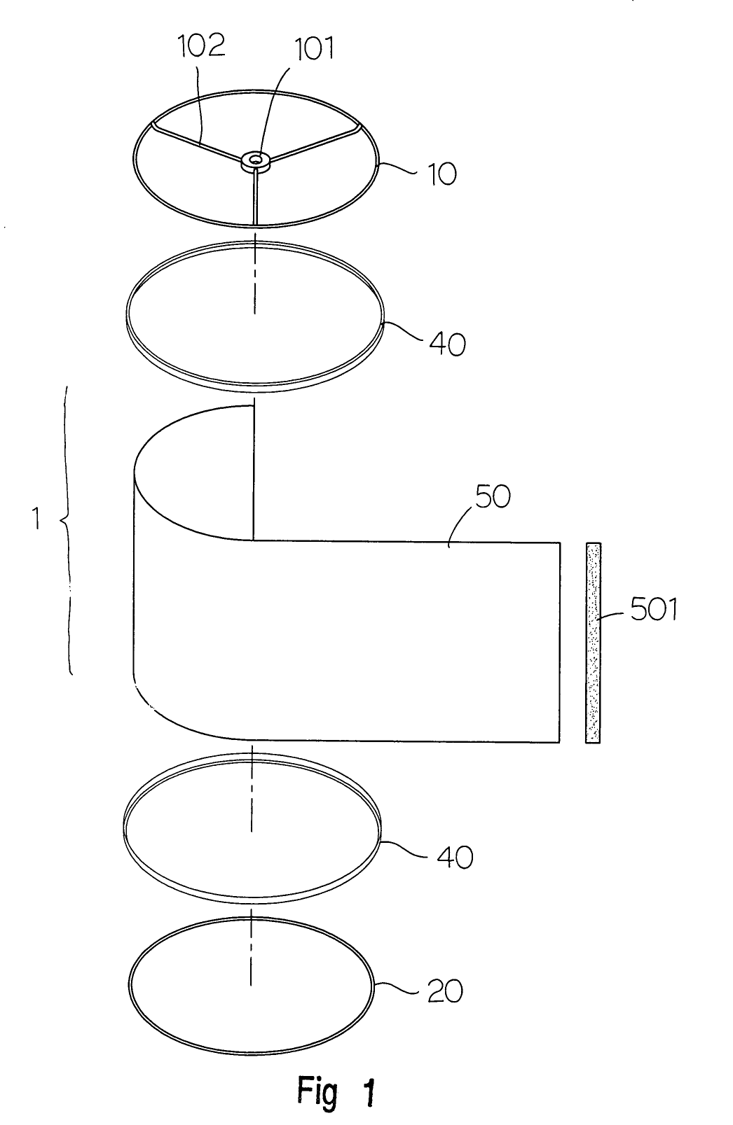

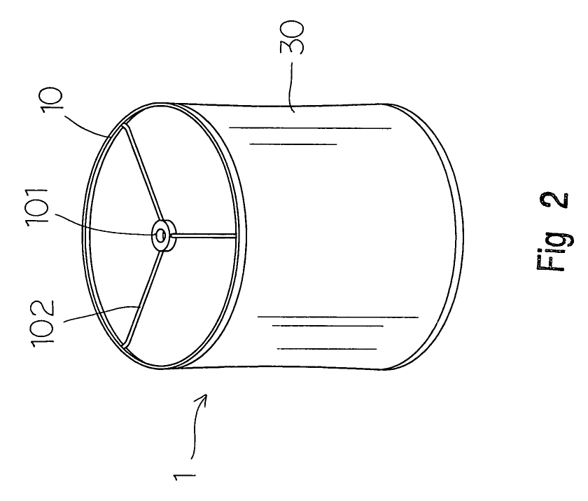

As shown in FIGS. 1 and 2, the lampshade (1) of this invention consists of an upper ring (10), a lower ring (20), and a shade (30), two retaining ring (40) and a support sheet (50). Where the upper ring (10) and the lower ring (20) are metal material in identical size and form with spider (101) and ribs (102) to brace them.

The shade (30) is wrapped along the upper ring (10) and the lower ring (20) to form a cylindrical body so as to contain the light within.

Two retaining rings (40), in L shape, are stuck to the upper ring (10) and the lower ring (20) respectively but form a gap (401) between the shade (30) and rings (10, 20).

The support sheet (50) is wound to from a cylindrical hollow and both ends of the sheet are adhered by a section of two-side adhesive tape (501). The rim of the support sheet (50) will be inserted into the gap (401) formed between the retaining rings (40) and the shade (30).

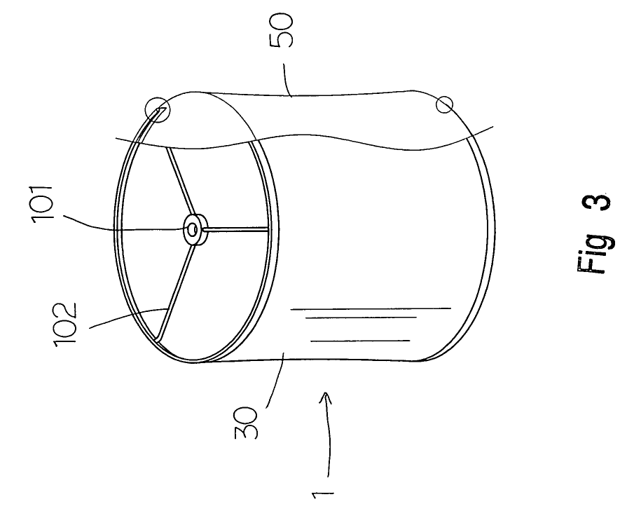

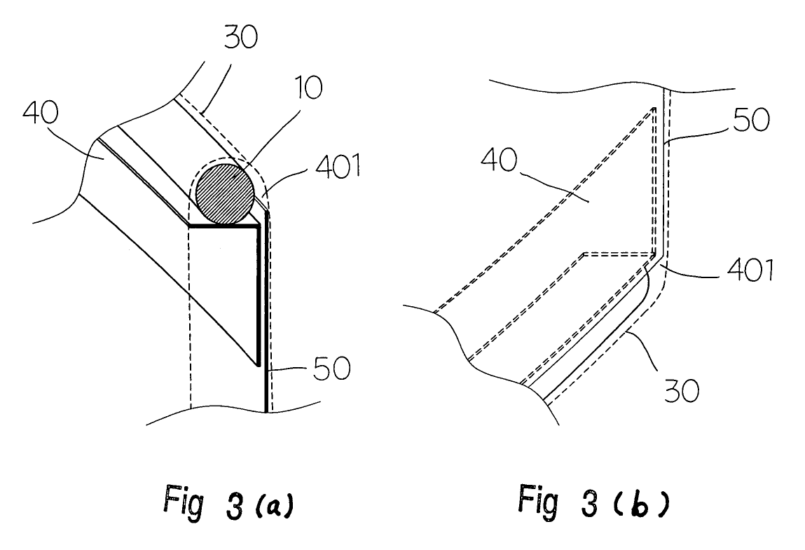

As shown in FIGS. 3, 3a and 3b, the physical practice is in this manner, the first is to stick two retaining rings (40) to the upper ring (10) and the lower ring (20) respectively. Wrapping the shade (30) on the upper ring (10) and the lower ring (20) and keep an adequate gap (401) between the retaining ring (40) and the shade (30). And finally winding the support sheet (50) to the upper ring (10) and the lower ring (20) and insert the support sheet (50) into the gap (401) to constitute a complete lampshade (1) as shown in FIG. 2.

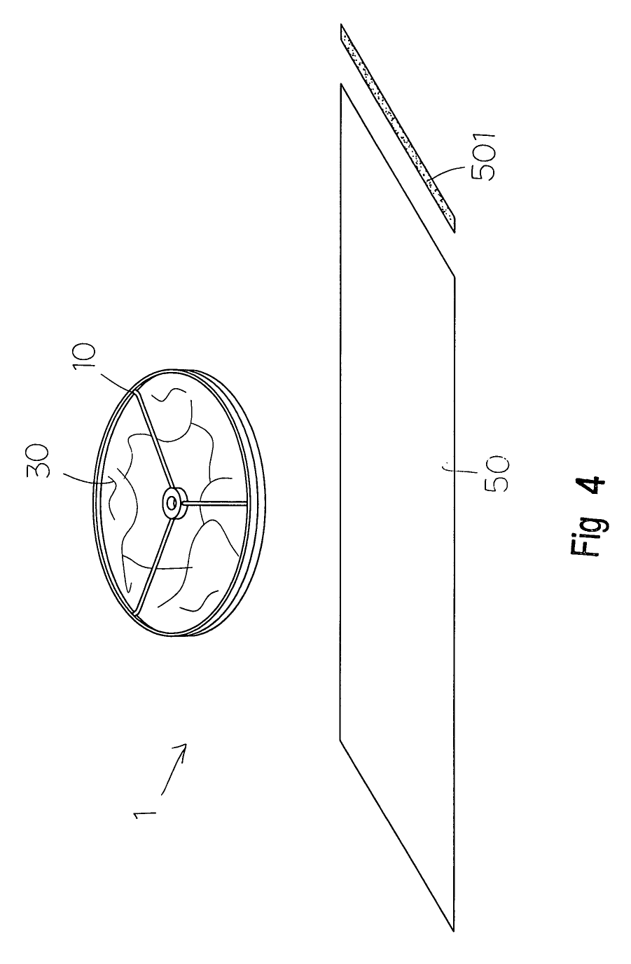

Please refer to FIG. 4, the schematic diagram shows individually the upper ring (10), the lower ring (20), two retaining rings (40), the shade (30) and the support sheet (50) in disassembled manner, easy for disassembly, storage and shipping with minimum space requirement.

The above statements indicate that this improved structure of the lampshade is novel invention, never exposed to the market, justified for grating a new patent.

1. A structure of the lampshade mainly comprises an upper ring, a lower ring, a shade, two retaining rings and a support sheet; in which the upper ring and lower ring are made of metal rod in identical size and form; the upper ring has a spider and three ribs to reinforce the structural strength, and the shade is wrapped around the upper and lower rings to form a cylindrical body so as to contain the light within; the key characteristics are: the retaining rings are in L shape, stuck to the upper and lower rings, but an adequate gap is formed from the shade; the support sheet is a hard sheet winding into cylindrical hollow and stuck together by a section of two-side adhesive tape at both ends; the support sheet will be inserted into the gap formed between the shade and two retaining rings; this assembly practice achieves easy, quick assembly and disassembly and great saving in time production cost.
